(19) United States
(12) Patent Application Publication
(10) Pub. No.: US 2025/0309297 A1
(43) Pub. Date: Oct. 2, 2025

(54) FUEL CELL SYSTEM, VEHICLE, AND METHOD OF MEASURING IMPEDANCE

(71) Applicant: SUBARU CORPORATION, Tokyo (JP)

(72) Inventor: Yushi FUKUTOMI, Tokyo (JP)

(21) Appl. No.: 18/865,087

(22) PCT Filed: Mar. 16, 2023
(86) PCT No.: PCT/JP2023/010289

§ 371 Date: Nov. 12, 2024

(51) Int. Cl. H01M 8/04537; H01M 8/04664

(52) U.S. Cl. CPC H01M 8/04641; H01M 8/04671; H01M 2250/20

(57) ABSTRACT

A fuel cell system includes a fuel cell, a power storage, an alternating-current load source, and a measuring unit. The power storage is configured to store electric power. The alternating-current load source is coupled on a path between the fuel cell and a load. The measuring unit is configured to measure an impedance of the fuel cell. The measuring unit is configured to determine a correction value with respect to a reference impedance value in a state where a load current does not flow from the fuel cell to the load, the correction value taking into consideration a generation of a noise due to the load current, and measure the impedance of the fuel cell, based on the determined correction value.

### TECHNICAL FIELD

The disclosure relates to a fuel cell system including a fuel cell, a vehicle including such a fuel cell system, and a method of measuring an impedance of a fuel cell.

### BACKGROUND ART

Various techniques have been disclosed as a fuel cell system including a fuel cell and a method of measuring an impedance of a fuel cell (e.g., see Patent Literature 1).

### CITATION LIST

### Patent Literature

Patent Literature 1: Japanese Patent No. 6458679

### SUMMARY OF INVENTION

An aspect of the disclosure provides a fuel cell system including a fuel cell, a power storage, an alternating-current load source, and a measuring unit. The power storage is configured to store electric power. The alternating-current load source is coupled on a path between the fuel cell and a load. The measuring unit is configured to measure an impedance of the fuel cell. The measuring unit is configured to determine a correction value with respect to a reference impedance value in a state where a load current does not flow from the fuel cell to the load, the correction value taking into consideration a generation of a noise due to the load current, and measure the impedance of the fuel cell, based on the determined correction value.

An aspect of the disclosure provides a vehicle provided with a fuel cell system. The fuel cell system includes a fuel cell, a power storage, an alternating-current load source, and a measuring unit. The power storage is configured to store electric power. The alternating-current load source is coupled on a path between the fuel cell and a load. The measuring unit is configured to measure an impedance of the fuel cell. The measuring unit is configured to determine a correction value with respect to a reference impedance value in a state where a load current does not flow from the fuel cell to the load, the correction value taking into consideration a generation of a noise due to the load current, and measure the impedance of the fuel cell, based on the determined correction value.

An aspect of the disclosure provides a method of measuring an impedance of a fuel cell of a fuel cell system. The fuel cell system includes the fuel cell, a power storage configured to store electric power, and an alternating-current load source coupled on a path between the fuel cell and a load. The method includes: determining a correction value with respect to a reference impedance value in a state where a load current does not flow from the fuel cell to the load, the correction value taking into consideration a generation of a noise due to the load current; and measuring the impedance of the fuel cell, based on the determined correction value.

### BRIEF DESCRIPTION OF DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a block diagram illustrating a schematic configuration example of a vehicle according to one embodiment of the disclosure.

FIG. 2 is a block diagram illustrating a detailed configuration example of a fuel cell system illustrated in FIG. 1.

FIG. 3A is a characteristic diagram illustrating an example of correspondence between real values and imaginary values of an impedance of a fuel cell.

FIG. 3B is a characteristic diagram illustrating another example of the correspondence between the real values and the imaginary values of the impedance of the fuel cell.

FIG. 4 is a flowchart illustrating an example of a process of measuring the impedance according to one embodiment.

FIG. 5 is a flowchart illustrating a detailed example of a process of deriving a correction value illustrated in FIG. 4.

FIG. 6 is a characteristic diagram for describing details of a process of setting the correction value illustrated in FIG. 5.

FIG. 7 is a flowchart illustrating a detailed example of the process of measuring the impedance based on the correction value illustrated in FIG. 4.

FIG. 8 is a flowchart illustrating an example of a process of measuring the impedance based on the correction value according to a modification example.

### MODES FOR CARRYING OUT THE INVENTION

In a fuel cell system including a fuel cell, it is desired to improve measurement accuracy of an impedance of the fuel cell.

It is desirable to provide a fuel cell system, a vehicle, and a method of measuring an impedance that make it possible to improve measurement accuracy of an impedance of a fuel cell.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### Embodiment

### [Schematic Configuration Example]

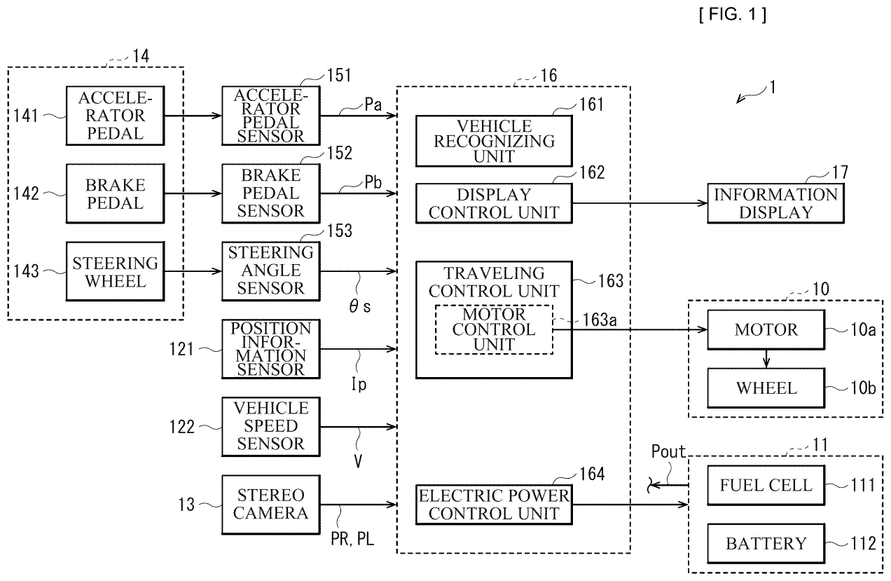

FIG. 1 illustrates, in a block diagram, a schematic configuration example of a vehicle (a vehicle 1) according to an embodiment of the disclosure. The vehicle 1 is equipped with a fuel cell system 11 including a fuel cell 111 to be described later, and is configured as a fuel cell vehicle.

The vehicle 1 includes a drive mechanism 10, a fuel cell system 11, a position information sensor 121, a vehicle speed sensor 122, a stereo camera 13, an operation receiving unit 14, an accelerator pedal sensor 151, a brake pedal sensor 152, a steering angle sensor 153, a vehicle controller 16, and an information display 17. Note that a method of measuring an impedance according to an embodiment of the disclosure is implemented by an operation (a process of measuring the impedance) in the fuel cell system 11 to be described later, and will be described together in the following.

### (Drive Mechanism 10)

The drive mechanism 10 includes a motor 10a (an electric motor) and a wheel 10b. The motor 10a generates driving torque of the vehicle 1, and the generated driving torque is transmitted to the wheel 10b. The number of the wheels 10b may be, for example, four in a case of a four-wheel automobile, or two in a case of a two-wheel automobile.

### (Fuel Cell System 11)

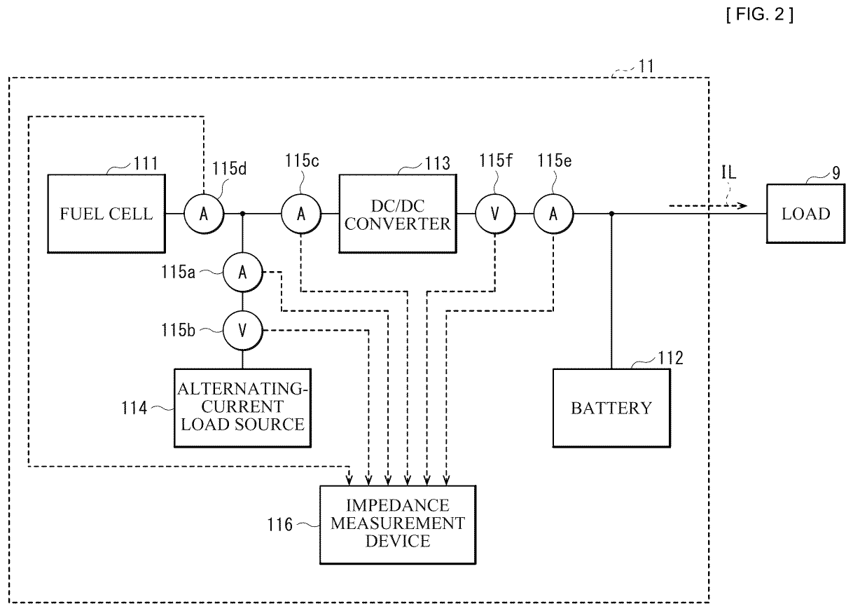

The fuel cell system 11 is a system including the fuel cell 111 and a battery 112. Electric power Pout that is outputted from the fuel cell system 11 is supplied to the entire vehicle 1, as electric power of the vehicle 1. A detailed configuration example of the fuel cell system 11 will be described later (FIG. 2).

### (Position Information Sensor 121 and Vehicle Speed Sensor 122)

The position information sensor 121 is a sensor that acquires position information Ip of the vehicle 1. The position information sensor 121 includes, for example, a GPS sensor that acquires the position information Ip of the vehicle 1 by receiving satellite signals from global positioning system (GPS) satellites. As the position information sensor 121, for example, an antenna that receives a satellite signal from another satellite system that identifies the position of the vehicle 1 may be used, instead of the GPS sensor. The position information Ip thus acquired by the position information sensor 121 is outputted to the vehicle controller 16 (e.g., a traveling control unit 163 to be described later).

The vehicle speed sensor 122 is a sensor that detects a speed, i.e., a vehicle speed V, of the vehicle 1. The vehicle speed V detected by the vehicle speed sensor 12 is outputted to the vehicle controller 16 (e.g., the traveling control unit 163 to be described later).

### (Stereo Camera 13)

The stereo camera 13 is a device, i.e., an imaging device, that captures an image of a surrounding situation or a traveling environment of the vehicle 1 and detects the surrounding situation or the traveling environment. The stereo camera 13 includes, for example, two cameras of a right camera and a left camera.

The right camera and the left camera each include, for example, a lens and an image sensor. For example, the right camera and the left camera are disposed in the vicinity of an upper portion of a windshield of the vehicle 1, being separated away from each other by a predetermined distance along a width direction of the vehicle 1. The right camera and the left camera perform imaging operations in a manner synchronized with each other. Specifically, the right camera generates a captured image PR (a right image), and the left camera generates a captured image PL (a left image). The captured images PR and PL thus obtained by the stereo camera 13 including the right camera and the left camera are each outputted to the vehicle controller 16 (e.g., a vehicle recognizing unit 161 and the traveling control unit 163 to be described later).

### (Information Display 17)

The information display 17 is a device that outputs or displays various kinds of information for an occupant of the vehicle 1. The occupant of the vehicle 1 is, for example, a driver. The information display 17 includes, for example, a head-up display (HUD) or any other display.

### (Operation Receiving Unit 14 and Various Sensors)

The operation receiving unit 14 includes an accelerator pedal 141, a brake pedal 142, and a steering wheel 143 (a steering wheel), as illustrated in FIG. 1. Each of the members of the operation receiving unit 14, i.e., each of the accelerator pedal 141, the brake pedal 142, and the steering wheel 143, receives an operation performed by the occupant, such as the driver, of the vehicle 1 at least through an electrical signal, i.e., by what is called a by-wire method.

The accelerator pedal sensor 151 is a sensor that detects an amount of pressing of the accelerator pedal 141 by the driver of the vehicle 1, i.e., an accelerator position Pa. The brake pedal sensor 152 is a sensor that detects an amount of pressing of the brake pedal 142 by the driver of the vehicle 1, i.e., a brake pressing amount Pb. The steering angle sensor 153 is a sensor that detects an amount of an operation performed on the steering wheel 143 by the driver of the vehicle 1, i.e., a steering angle θs.

Each of the accelerator position Pa, the brake pressing amount Pb, and the steering angle θs detected by the accelerator pedal sensor 151, the brake pedal sensor 152, and the steering angle sensor 153, respectively, is outputted to the vehicle controller 16 (e.g., the traveling control unit 163 to be described later).

### (Vehicle Controller 16)

The vehicle controller 16 is a member, i.e., a control unit, that controls various operations of the vehicle 1, and perform various calculation processes. Specifically, the vehicle controller 16 includes one or more processors, i.e., a central processing unit (CPU), and one or more memories, for example. The one or more processors execute programs. The one or more memories are communicably coupled to the one or more processors. The one or more memories include, for example, a random-access memory (RAM) and a read-only memory (ROM). The RAM temporarily holds processing data. The ROM holds programs.

In the example illustrated in FIG. 1, the vehicle controller 16 includes the vehicle recognizing unit 161, a display control unit 162, the traveling control unit 163, and an electric power control unit 164.

The vehicle recognizing unit 161 is a unit that recognizes another vehicle other than the vehicle 1 as an own vehicle, by performing a predetermined calculation process, such as an image recognition process, based on the captured images PR and PL each obtained by the stereo camera 13, i.e., obtained by the right camera and the left camera, respectively. Specifically, the vehicle recognizing unit 161 recognizes, for example, a preceding vehicle traveling in front of the vehicle 1 as the other vehicle.

The display control unit 162 is a unit that controls a display operation, i.e., an operation of displaying various kinds of information, performed by the information display 17 (see FIG. 1).

The traveling control unit 163 is a unit that controls a traveling operation of the vehicle 1. The traveling control unit 163 performs a comprehensive control related to traveling of the vehicle 1. Specifically, the traveling control unit 163 performs, for example, an automated driving control of the vehicle 1. The automated driving control includes an automatic control of a driving system, a braking system, and a steering system of the vehicle 1. In a predetermined case, the traveling control unit 163 causes transition from an automated driving mode to a manual driving mode to be performed, in other words, shifts a driving mode. The automated driving mode is a driving mode in which the automated driving control is performed. The manual driving mode is a driving mode in which manual driving based on the operation received by the operation receiving unit 14 is performed.

The traveling control unit 163 includes a motor control unit 163a in the example illustrated in FIG. 1. The motor control unit 163a is a unit that controls various operations of the motor 10a (see FIG. 1). Specifically, the motor control unit 163a controls, for example, a driving operation of the wheel 10b performed by the motor 10a, a regenerative operation performed by the motor 10a, and any other operation.

The traveling control unit 163 also controls the traveling operation of the vehicle 1 based on, for example, a recognition result related to another vehicle obtained by the vehicle recognizing unit 161 described above. The recognition result related to the other vehicle includes, for example, an inter-vehicle distance between the vehicle 1 and the other vehicle. Specifically, the traveling control unit 163 performs an automatic following control related to the other vehicle or a preceding vehicle, an automatic acceleration and deceleration control, or any other control by increasing and decreasing the inter-vehicle distance between the vehicle 1 and the other vehicle, the vehicle speed V described above, or any other factor. The automatic acceleration and deceleration control refers to a control of automatic deceleration and automatic acceleration.

The electric power control unit 164 is a unit that controls operations (e.g., power generation and charging) of the fuel cell system 11. Specifically, the electric power control unit 164 controls the power generation of the fuel cell 111 based on, for example, requested electric power of the motor 10a. For example, when the electric power generated by the fuel cell 111 exceeds the requested electric power described above, the electric power control unit 164 charges the battery 112 with extra electric power of electric power outputted from a DC/DC converter 113, i.e., a converter, to be described later. In contrast, for example, when the electric power generated by the fuel cell 111 is less than the requested electric power described above, the electric power control unit 164 complements the insufficient electric power by electric power outputted by the battery 112. Further, the electric power control unit 164 charges the battery 112 with regenerative electric power of the motor 10a, for example, at the time of deceleration of the vehicle 1.

### [Detailed Configuration Example of Fuel Cell System 11]

Next, the detailed configuration example of the above-described fuel cell system 11 will be described referring to FIG. 2. FIG. 2 illustrates, in a block diagram, the detailed configuration example of the fuel cell system 11 illustrated in FIG. 1, together with a load 9 of the fuel cell system 11. In FIG. 2, a load current IL that flows from the fuel cell system 11 or the fuel cell 111 to the load 9 is also indicated by a dashed-line arrow.

In the example of FIG. 2, the fuel cell system 11 includes the fuel cell 111 and the battery 112 described above, the DC/DC converter 113, an alternating-current load source 114, four ammeters 115a, 115c, 115d, and 115e, two voltmeters 115b and 115f, and an impedance measurement device 116. Examples of the load 9 described above include the motor 10a described above, an inverter, and any other device. The inverter is a device that converts direct-current electric power outputted from the DC/DC converter 113 to be described later into three-phase alternating-current electric power, and supplies the resulting electric power to the motor 10a.

Here, the battery 112 corresponds to a specific example of a “power storage” according to an embodiment of the disclosure. The impedance measurement device 116 corresponds to a specific example of a “measuring unit” according to an embodiment of the disclosure.

The fuel cell 111 is configured as, for example, a solid polymer electrolyte fuel cell, and has a stacked structure including multiple fuel cells stacked. Each fuel cell includes a hydrogen electrode and an oxygen electrode provided on respective opposite sides of an electrolyte membrane including an ion exchange membrane. On the hydrogen electrode and the oxygen electrode is provided, for example, a membrane electrode assembly (MEA) provided with gas diffusion layers. Further, each fuel cell includes a pair of separators disposed to sandwich the MEA. Hydrogen gas is supplied to a hydrogen gas flow channel provided for the hydrogen electrode, and air is supplied to an air flow channel provided for the oxygen electrode. The hydrogen gas and air thus supplied electrochemically react with each other, which allows for power generation. Note that the electric power (direct-current electric power) generated by the fuel cell 111 is outputted to the DC/DC converter 113.

The battery 112 is configured to store electric power (direct-current electric power) supplied from the fuel cell 111 through the DC/DC converter 113. The battery 112 includes any of various secondary batteries such as, for example, a lithium-ion battery. The battery 112 stores, for example, the regenerative electric power supplied from the motor 10a, as well as the electric power, i.e., generated electric power, obtained by the power generation of the fuel cell 111.

The DC/DC converter 113 is a device that converts the direct-current electric power outputted from the fuel cell 111 into direct-current electric power at a predetermined level and outputs the resulting electric power. The DC/DC converter 113 includes any of various switching circuits (e.g., a chopper circuit). The direct-current electric power thus subjected to level conversion and outputted from the DC/DC converter 113 is stored in the battery 112 or supplied to the load 9.

The alternating-current load source 114 is coupled on a path between the fuel cell 111 and the load 9. The alternating-current load source 114 is configured as a load source of an alternating current at the time of measuring an impedance Z of the fuel cell 111, which will be described later. Specifically, the alternating-current load source 114 is coupled in parallel with the load 9 and the DC/DC converter 113 to the fuel cell 111. In the example of FIG. 2, the alternating-current load source 114 is coupled to be branched from a path between the fuel cell 111 and the DC/DC converter 113.

Each of the ammeters 115a, 115c, 115d, and 115e is a device that measures a current that flows on a predetermined path. Specifically, the ammeter 115d measures a current outputted from the fuel cell 111. The ammeter 115a measures a current flowing from the fuel cell 111 to the alternating-current load source 114 side. The ammeter 115c measures a current flowing from the fuel cell 111 to the DC/DC converter 113 side. The ammeter 115a measures a current outputted from the DC/DC converter 113. Measured values of the currents obtained by the ammeters 115a, 115c, 115d, and 115e are each supplied to the impedance measurement device 116 to be described later.

Each of the voltmeters 115b and 115f is a device that measures a voltage on a predetermined path. Specifically, the voltmeter 115b measures a voltage on a path coupled to the alternating-current load source 114, i.e., a path branched from the fuel cell 111 to the alternating-current load source 114 side. The voltmeter 115f measures a voltage outputted from the DC/DC converter 113. Measured values of the voltages obtained by the voltmeters 115b and 115f are each supplied to the impedance measurement device 116 to be described later.

Note that, among the ammeters 115a, 115c, 115d, and 115e and the voltmeters 115b and 115f, for example, at least one of the ammeter 115d, the ammeter 115e, or the voltmeter 115f may not be provided in the fuel cell system 11.

The impedance measurement device 116 is a device, i.e., a measuring unit, configured to measure the impedance Z (internal impedance) of the fuel cell 111. Specifically, in the example of FIG. 2, the impedance measurement device 116 measures the impedance Z, based on the measured values of the currents obtained by the ammeters 115a, 115c, 115d, and 115e and the measured values of the voltages obtained by the voltmeters 115b and 115f. Further, when performing such measurement of the impedance Z, the impedance measurement device 116 performs various calculation processes.

The impedance measurement device 116 includes, for example, one or more processors, i.e., a CPU, and one or more memories. The one or more processors execute programs. The one or more memories are communicably coupled to the one or more processors. The one or more memories include, for example, a RAM and a ROM. The RAM temporarily holds processing data. The ROM holds programs.

The impedance measurement device 116 measures the impedance Z of the fuel cell 111 by, for example, a predetermined frequency analysis. Specifically, the impedance measurement device 116 uses, for example, fast Fourier transform (FFT) analysis as an example of such a predetermined frequency analysis, and measures the impedance Z of the fuel cell 111 by an alternating-current impedance method in accordance with the following method in the order of steps A to E.
Step A: Coupling the load 9 to the fuel cell 111, and outputting a direct current as the load current IL from the fuel cell 111.
Step B: Superimposing an alternating-current component on the direct current.
Step C: Measuring a response (voltage and current characteristics) of the superimposed alternating-current component.
Step D: Calculating, by Fourier calculation, each of an absolute value |Z|, a real value X=ReZ (a value of a real part), and an imaginary value Y=ImZ (a value of an imaginary part) of the impedance Z at a specific frequency, as represented by the following expressions (a) to (c).
Step E: Creating what is called a “Cole-Cole plot”, which is a plot indicating the correspondence between the real value X and the imaginary value Y of the impedance Z, based on analysis results at multiple frequencies of the superimposed alternating current.

$$\vert Z \vert = \vert Urms ( Uac ) \vert / \vert Irms ( Iac ) \vert \qquad ( a )$$

$$X = ( U r m s ( U ac ) / Irms ( I a c ) ) \times cos φ \qquad ( b )$$

$$Y = ( U r m s ( U ac ) / Irms ( I a c ) ) \times sin φ \qquad ( c )$$

Urms(Uac): Effective value of alternating-current voltage
Irms(Iac): Effective value of alternating current
φ: Phase difference between alternating-current voltage and alternating current

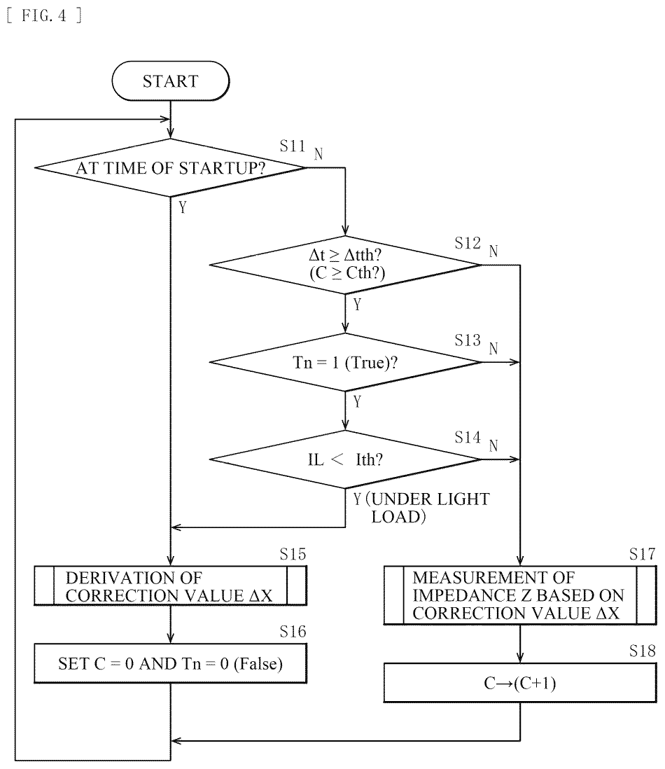

In the present embodiment, although details will be described later, in a state where the load current IL does not flow from the fuel cell 111 to the load 9, the impedance measurement device 116 determines a correction value ΔX with respect to a reference impedance value X0 (real value) to be described later. The correction value ΔX is a correction value taking into consideration a generation of a noise due to the load current IL. The “state where the load current IL does not flow” corresponds to, for example, a state before the traveling of the vehicle 1, a state immediately after a startup of the fuel cell system 11, or a state where the vehicle 1 is stopped. The impedance measurement device 116 measures the impedance Z of the fuel cell 111, based on the correction value ΔX thus determined. Note that details of a method of measuring the impedance Z in the present embodiment, i.e., the method of measuring the impedance Z by the predetermined frequency analysis (FFT analysis) described above, will be described later (FIGS. 4 to 7).

### Operations, Workings, and Effects

Next, operations, workings, and effects of the present embodiment will be described in detail.

### (A. Measurement of Impedance of Fuel Cell)

First, a typical example of a cost-saving measure for a vehicle equipped with a fuel cell is to simplify a humidifying mechanism by allowing for power generation in a low humidity state of an electrolyte membrane of a fuel cell stack. However, realizing this measure involves an issue of precise humidity detection inside the fuel cell stack. Specifically, water management inside the fuel cell for the vehicle is important, and a water content of the fuel cell has to be accurately measured. Used as a technique for measuring the content is measurement of the impedance of the fuel cell, i.e., the alternating-current impedance measurement by the alternating-current impedance method described above. For example, this is performed by superimposing an alternating-current component on a control signal, in a control (switching control) of a DC/DC converter.

This method does not allow for measurement of the impedance of the fuel cell in some cases, for example, in a situation where a negative current is not extractable from the fuel cell, such as before the startup of the fuel cell system, during regeneration of a motor, or after a stop of the power generation of the fuel cell. However, in a method using an alternating-current load source on a path between the fuel cell and a load, a noise can be generated due to the load current described above, resulting in a decrease in measurement accuracy, as described below.

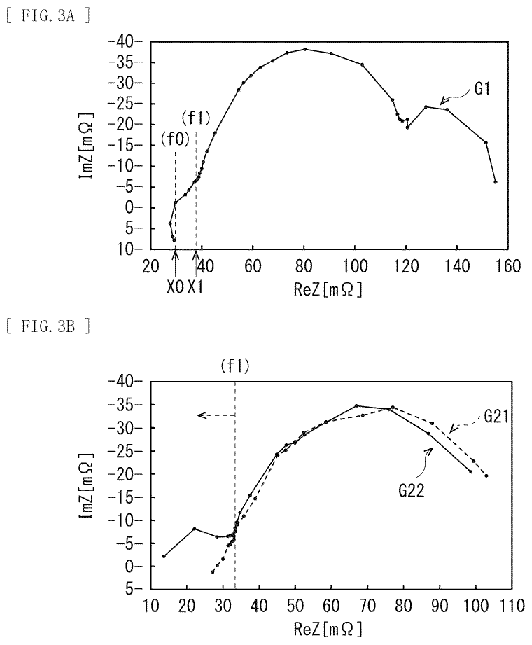

Here, FIGS. 3A and 3B each illustrate an example, i.e., a characteristic example, of correspondence between the real value (ReZ [mΩ]) and the imaginary value (ImZ [mΩ]) of the impedance Z of the fuel cell 111. Specifically, FIG. 3A illustrates the characteristic example when the load current IL=100 A, represented by a reference sign G1. Note that FIG. 3A illustrates each of a predetermined reference frequency f0 (e.g., f0=4000 [Hz]) and a predetermined noise determination frequency f1 (e.g., f1=700 [Hz]) to be described later, the real value ReZ=X0 at the reference frequency f0, and the real value ReZ=X1 at the noise determination frequency f1. FIG. 3B illustrates each of the characteristic example when the noise due to the load current IL described above is not generated, represented by a reference sign G21, and a characteristic example when the noise due to the load current IL is generated, represented by a reference sign G22.

First, it is understood from FIG. 3A that (the real value of) the impedance Z differs depending on the frequency. Further, it is understood from FIG. 3B that, in a state where the load current IL flows, the noise due to the load current IL is generated, resulting in a larger difference between the characteristic examples represented by the reference signs G21 and G22, on the high frequency side with respect to the noise determination frequency f1 described above. This is indicated by a dashed-line arrow in FIG. 3B.

### (B. Process Example of Measuring Impedance Z)

Hence, the fuel cell system 11 of the present embodiment performs the process of measuring the impedance Z of the fuel cell 111 as follows, for example. In the following description, the real value X of the impedance Z described above is referred to as an impedance value X as appropriate.

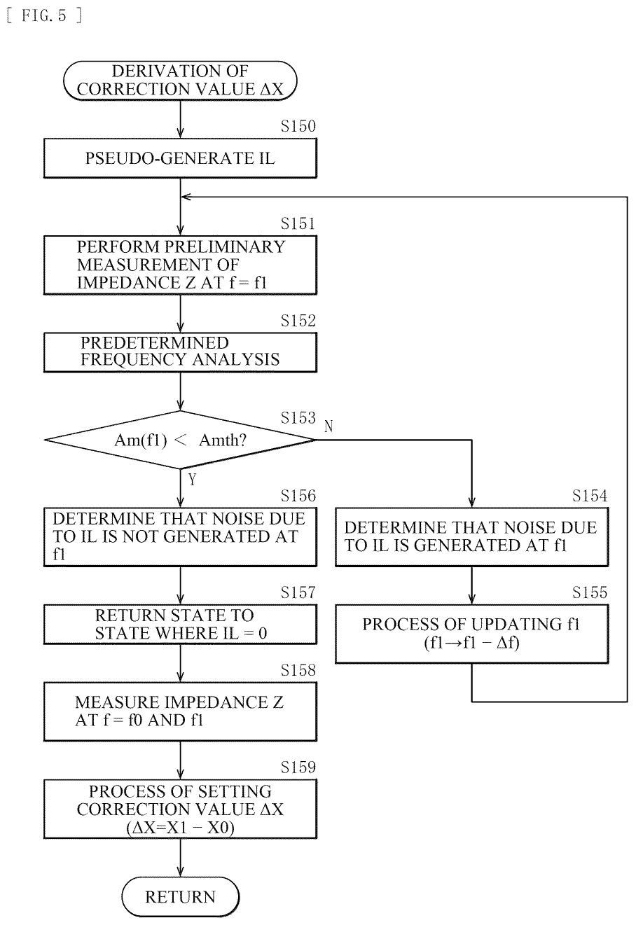

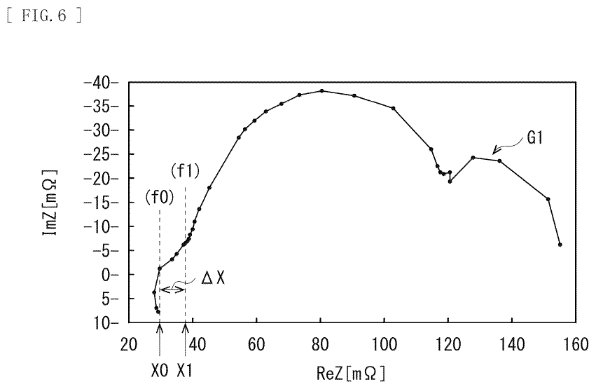

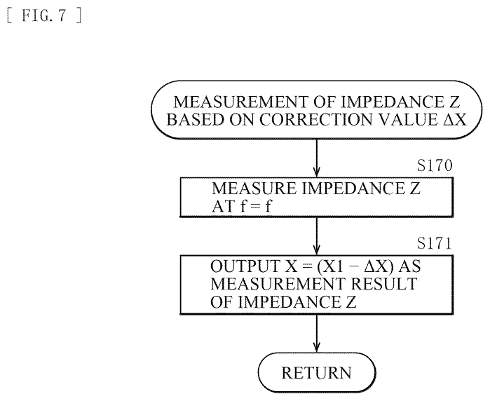

Here, FIG. 4 illustrates, in a flowchart, an example of the process of measuring the impedance Z according to the present embodiment. FIG. 5 illustrates, in a flowchart, a detailed example of a process of deriving the correction value ΔX illustrated in FIG. 4 (a process of step S15 to be described later). FIG. 6 is a characteristic diagram for describing details of a process of setting the correction value ΔX illustrated in FIG. 5. FIG. 6 is based on the characteristic example of FIG. 3A described above, which is an example of the correspondence between the real value and the imaginary value of the impedance Z. FIG. 7 illustrates, in a flowchart, a detailed example of a process of measuring the impedance Z based on the correction value ΔX illustrated in FIG. 4 (a process of step S17 to be described later).

### (B-1. Entire Process Example)

In the series of process examples (the process example of measuring the impedance Z) illustrated in FIGS. 4 to 7, first, the impedance measurement device 116 performs the following determination. That is, the impedance measurement device 116 determines whether it is the time of the startup of the fuel cell system 11 (step S11 of FIG. 4). Here, if it is determined that it is the time of the startup of the fuel cell system 11 (step S11: Y), the process proceeds to the process of deriving the correction value ΔX to be described later (step S15).

In contrast, if it is determined that it is not the time of startup of the fuel cell system 11 (step S11: N), the impedance measurement device 116 thereafter performs the following determination. That is, the impedance measurement device 116 determines whether an elapsed time Δt from the time of setting the correction value ΔX at present is equal to or greater than a predetermined threshold Δtth, i.e., a second threshold (Δt≥Δtth) (step S12). Specifically, the impedance measurement device 116 determines whether the elapsed time Δt is equal to or greater than the threshold Δtth, based on whether a count value C is equal to or greater than a predetermined threshold Cth (C≥Cth). The count value C takes an initial value (=0) at the time of setting the correction value ΔX at present.

Here, if it is determined that the elapsed time Δt is less than the threshold Δtth (Δt<Δtth), i.e., the count value C described above is less than the threshold Cth (C<Cth) (step S12: N), the process proceeds to the process of measuring the impedance Z based on the correction value ΔX, which will be described later (step S17). In contrast, if it is determined that the elapsed time Δt is equal to or greater than the threshold Δtth (Δt≥Δtth), i.e., the count value C described above is equal to or greater than the threshold Cth (C≥Cth) (step S12: Y), the impedance measurement device 116 thereafter performs the following determination. That is, the impedance measurement device 116 determines whether a predetermined noise trigger Tn=1 representing “True” (step S13).

The noise trigger Tn is a parameter that indicates the value of “1 (True)” when a determination has been made that the noise due to the load current IL described above has been actually generated in the previous measurement of the impedance Z based on the correction value ΔX. Therefore, conversely, the noise trigger Tn indicates the value of “0 (False)” when a determination has been made that the noise due to the load current IL has not been actually generated in the previous measurement of the impedance Z based on the correction value ΔX.

Here, if it is determined that Tn=0 (False), i.e., the noise described above is not actually generated in the previous measurement described above (step S13: N), the process proceeds to the process of measuring the impedance Z based on the correction value ΔX, which will be described later (step S17). In contrast, if it is determined that Tn=1 (True), i.e., the noise described above is actually generated in the previous measurement described above (step S13: Y), the impedance measurement device 116 thereafter performs the following determination. That is, the impedance measurement device 116 determines whether the load current IL described above is less than a predetermined threshold Ith, i.e., a third threshold (IL<Ith), in other words, whether the load 9 is a light load, based on the measured values of the currents obtained by the ammeters 115e, 115c, 115d, etc. (step S14). The load 9 being a light load is a state under a light load.

Here, if it is determined that the load current IL is equal to or greater than the threshold Ith, indicating a state not under a light load (step S14: N), the process proceeds to the process of measuring the impedance Z based on the correction value ΔX, which will be described later (step S17). In contrast, if it is determined that the load current IL is less than the threshold Ith, indicating the state under a light load (step S14: Y), the impedance measurement device 116 thereafter performs the process of deriving the correction value ΔX (step S15). Details of the process of step S15 will be described later (FIGS. 5 and 6).

Thereafter, the impedance measurement device 116 sets the count value C and the noise trigger Tn described above to the respective initial values, i.e., C=0 and Tn=0 (False) (step S16). The process thereafter returns to step S11 described above.

In step S17 described above, the impedance measurement device 116 performs the process of measuring the impedance Z based on the correction value ΔX. Details of the process of step S17 will be described later (FIG. 7). Thereafter, the impedance measurement device 116 updates or counts up the count value C described above to a value of (C+1) (step S18). The process thereafter returns to step S1 described above.

### (B-2. Process Example of Deriving Correction Value ΔX)

Next, details of the process of deriving the correction value ΔX described above (step S15) will be described referring to FIGS. 5 and 6.

In the process of deriving the correction value ΔX, first, for example, the electric power control unit 164 described above is used to pseudo-generate the load current IL (e.g., IL=10 [A]) (step S150 of FIG. 5). The impedance measurement device 116 thereafter performs preliminary measurement of the impedance Z of the fuel cell 111 by the method described above at the noise determination frequency f1 (frequency f=f1) described above (step S151). Thereafter, the impedance measurement device 116 performs the predetermined frequency analysis (FFT analysis) described above, based on a result of such preliminary measurement of the impedance Z at the noise determination frequency f1 (step S152). The impedance measurement device 116 determines whether an amplitude value Am(f1) at the noise determination frequency f1, obtained as a result of the frequency analysis, is less than a predetermined threshold Amth, i.e., a first threshold (step S153).

Here, if it is determined that the amplitude value Am(f1) is equal to or greater than the threshold Amth (Am(f1)≥Amth) (step S153: N), the impedance measurement device 116 determines that the noise due to the load current IL described above is generated at the noise determination frequency f1 (step S154). In this case, the impedance measurement device 116 performs a process of updating the noise determination frequency f1 (step S155), without performing the process of setting the correction value ΔX to be described later (step S159). Specifically, the impedance measurement device 116 performs the process of updating the noise determination frequency f1 to a value (f1−Δf) obtained by subtracting a predetermined frequency Δf (e.g., Δf=10 [Hz]) from the noise determination frequency f1 at present. The process thereafter returns to step S151 described above.

In contrast, if it is determined that the amplitude value Am(f1) described above is less than the threshold Amth (Am(f1)<Amth) (step S153: Y), the impedance measurement device 116 determines that the noise due to the load current IL described above is not generated at the noise determination frequency f1 (step S156). Thereafter, in this case, for example, the electric power control unit 164 described above is used to return the state to the state where the load current IL does not flow, i.e., a state where IL=0 (step S157). The impedance measurement device 116 thus measures the impedance Z of the fuel cell 111 at each of the reference frequency f0 and the noise determination frequency f1 described above, in the state where the load current IL does not flow (step S158). In other words, the impedance measurement device 116 measures the reference impedance value X0 (real value) described above at the reference frequency f0, and measures the impedance value X1 (real value) described above at the noise determination frequency f1.

Thereafter, the impedance measurement device 116 performs the process of setting the correction value ΔX described above, based on the reference impedance value X0 and the impedance value X1 thus measured in the state where the load current IL does not flow as described above (step S159). Specifically, for example, as illustrated in FIG. 6, a value (X1−X0) obtained by subtracting the reference impedance value X0 at the reference frequency f0 from the impedance value X1 at the noise determination frequency f1 is set as the correction value ΔX.

This is the end of the detailed description of the process of deriving the correction value ΔX (step S15) illustrated in FIG. 5.

### (B-3. Process Example of Measuring Impedance Z Based on Correction Value ΔX)

Next, details of the process of measuring the impedance Z based on the correction value ΔX described above (step S17) will be described referring to FIG. 7.

In the process of measuring the impedance Z based on the correction value ΔX, first, the impedance measurement device 116 measures the impedance Z of the fuel cell 111 at the noise determination frequency f1 (step S170). The impedance measurement device 116 outputs, as a measurement result of (the real value of) the impedance Z, a value (X1−ΔX) obtained by subtracting the correction value ΔX derived in step S15 (step S159) from the impedance value X1 (real value) measured at the noise determination frequency f1 (step S171).

This is the end of the detailed description of the process of measuring the impedance Z based on the correction value ΔX (step S17) illustrated in FIG. 7.

### (C. Workings and Effects)

As described above, in the fuel cell system 11 of the present embodiment, the alternating-current load source 114 is coupled on the path between the fuel cell 111 and the load 9. In the state where the load current IL does not flow from the fuel cell 111 to the load 9, the impedance measurement device 116 determines the correction value ΔX with respect to the reference impedance value X0 described above. The correction value ΔX is the correction value taking into consideration the generation of the noise due to the load current IL. The impedance measurement device 116 measures the impedance Z of the fuel cell 111, based on the correction value ΔX thus determined.

In this manner, in the present embodiment, the impedance Z of the fuel cell 111 is measured based on the correction value ΔX taking into consideration the generation of the noise due to the load current IL, which suppresses a decrease in the measurement accuracy caused by such a noise due to the load current IL. Consequently, the present embodiment makes it possible to improve the measurement accuracy of the impedance Z of the fuel cell 111.

Further, in the present embodiment, it is possible to measure the impedance Z, for example, even in a situation where the negative current described above is not extractable from the fuel cell 111. Moreover, in the present embodiment, a current sensor for measurement of the impedance Z (the ammeters 115a, 115c, 115d, and 115e) does not have to measure a high current as in an existing technique, which makes it unnecessary to provide a current sensor dedicated to the fuel cell. Consequently, it is possible to measure the impedance Z of the fuel cell 111 at low cost.

Further, in the present embodiment, the impedance measurement device 116 measures the reference impedance value X0 at the reference frequency f1 and measures the impedance value X1 at the noise determination frequency f1 in the state where the load current IL does not flow. The impedance measurement device 116 sets, as the correction value ΔX, a value obtained by subtracting the reference impedance value X0 from the impedance value X1 at the noise determination frequency f1. Thus, the correction value ΔX described above is obtainable by a simple method.

Moreover, in the present embodiment, the impedance measurement device 116 performs the predetermined frequency analysis based on the result of the preliminary measurement of the impedance Z of the fuel cell 111 at the noise determination frequency f1, in a state where the load current IL is pseudo-generated. The impedance measurement device 116 operates as follows when the amplitude value Am(f1) at the noise determination frequency f1, obtained as the result of the frequency analysis, is less than the predetermined threshold Amth. That is, in this case, the impedance measurement device 116 determines that the noise due to the load current IL is not generated at the noise determination frequency f1, returns the state to the state where the load current IL does not flow, and thereafter performs the process of setting the correction value ΔX. In this manner, the process of setting the correction value ΔX is performed in accordance with a situation of generation of the noise in the state where the load current IL is pseudo-generated, which makes it possible to further improve the measurement accuracy of the impedance Z of the fuel cell 111.

### Modification Example

Next, a modification example of the above-described embodiment will be described. In the following, the same components as those in the embodiment will be denoted by the same reference numerals, and description will be omitted as appropriate.

### Process Example According to Modification Example

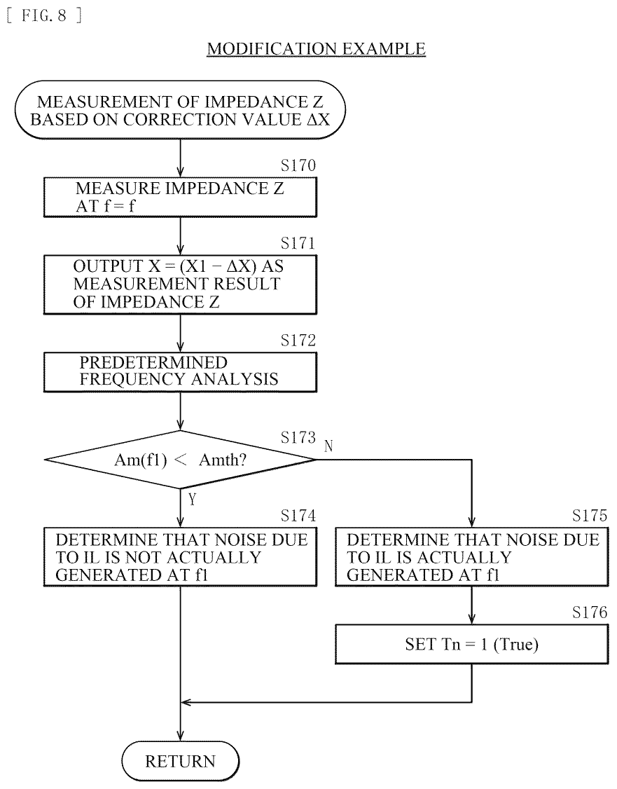

FIG. 8 illustrates, in a flowchart, an example of the process of measuring the impedance Z based on the correction value ΔX (the process of step S17 in FIG. 4) according to the modification example.

The process illustrated in FIG. 8 includes, in the process of FIG. 7 described in the embodiment, processes of step S172 to S176 described below added after the process of step S171 described above. Therefore, described below are the processes of added steps S172 to S176.

First, after the process of step S171 described above, the impedance measurement device 116 performs the predetermined frequency analysis (FFT analysis) described above, based on the measurement result of the impedance Z at the noise determination frequency f1 in step S170 described above (step S172). The impedance measurement device 116 determines whether the amplitude value Am(f1) at the noise determination frequency f1, obtained as the result of the frequency analysis, is less than the threshold Amth described above (step S173). In other words, after the impedance Z is measured based on the correction value ΔX, i.e., after the processes of steps S170 and S171 described above, the impedance measurement device 116 determines whether the noise due to the load current IL is actually generated at the noise determination frequency f1, based on the frequency analysis described above.

Here, if it is determined that the amplitude value Am(f1) is less than the threshold Amth (Am(f1)<Amth) (step S173: Y), the impedance measurement device 116 determines that the noise due to the load current IL described above is not actually generated at the noise determination frequency f1 (step S174). In this case, the process illustrated in FIG. 8 ends.

In contrast, if it is determined that the amplitude value Am(f1) described above is equal to or greater than the threshold Amth (Am(f1)≥Amth) (step S173: N), the impedance measurement device 116 determines that the noise due to the load current IL described above is actually generated at the noise determination frequency f1 (step S175). In this case, the impedance measurement device 116 sets the noise trigger Tn described above to 1 (True) (step S176). It is thus indicated that a determination has been made that the noise due to the load current IL has been actually generated in the previous measurement of the impedance Z based on the correction value ΔX. In this case, the process illustrated in FIG. 8 ends.

### (Workings and Effects)

In this manner, in the present modification example, after measuring the impedance Z of the fuel cell 111 based on the correction value ΔX, the impedance measurement device 116 determines whether the noise due to the load current IL is actually generated at the noise determination frequency f1, based on the predetermined frequency analysis. Thus, the impedance Z is measured in consideration of whether such noise is actually generated, which makes it possible to further improve the measurement accuracy of the impedance Z of the fuel cell 111.

### Other Modification Examples

Although some embodiments and modification examples of the disclosure have been described in the foregoing by way of example with reference to the accompanying drawings, the disclosure is by no means limited to the embodiments and the modification examples described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

For example, the configurations (e.g., types, arrangements, or the numbers of pieces) of the respective members of the vehicle 1, the operation receiving unit 14, the vehicle controller 16, the fuel cell system 11, and any other component are not limited to those described in the embodiments and the modification examples described above. That is, regarding the respective configurations of the above-described members, types, arrangements, the numbers of pieces, etc. other than those described may be employed. Specifically, for example, in the embodiments and the modification examples described above, a case where one motor (the motor 10a) is provided in the vehicle 1 has been described as an example, but the disclosure is not limited to this example. That is, for example, multiple motors, i.e., two or more motors, may be provided in the vehicle 1. In addition, values, ranges, magnitude relationships, etc., of the various parameters described in the embodiments and the modification examples described above are non-limiting. Other values, ranges, magnitude relationships, etc. may be employed.

For example, although in the embodiments and the modification examples described above, some specific examples are referred to in relation to various processes to be performed by the vehicle 1, the vehicle controller 16, and the fuel cell system 11, the processes are not limited to the above-described specific examples. That is, the various processes may be performed by any other method.

Further, the series of processes described in the embodiments and the modification examples described above may be performed by hardware such as a circuit, software such as a program, or a combination of hardware and software. When the processes are performed by software, the software includes a group of programs that causes a computer to execute respective operations. Each of the programs may be incorporated in the computer in advance, or may be installed on the computer via a network or a recording medium.

In addition, in the embodiments and the modification examples described above, the fuel cell system to be applied to a vehicle has been described as an example, but the disclosure is not limited to this example. For example, the fuel cell system according to an embodiment of the disclosure may be applied to other devices and systems other than a vehicle.

The various examples described above may be applied in any combination.

The effects described herein are mere examples, and effects of the disclosure are not limited to those described herein. Accordingly, the disclosure may achieve any other effect.

The disclosure may also encompass the following configurations.

(1)

A fuel cell system including:
a fuel cell;
a power storage configured to store electric power;
an alternating-current load source coupled on a path between the fuel cell and a load; and
a measuring unit configured to measure an impedance of the fuel cell, in which
the measuring unit is configured to
determine a correction value with respect to a reference impedance value in a state where a load current does not flow from the fuel cell to the load, the correction value taking into consideration a generation of a noise due to the load current, and
measure the impedance of the fuel cell, based on the determined correction value.
   (2)

The fuel cell system according to (1), in which the measuring unit is configured to,
in the state where the load current does not flow,
measure the reference impedance value of the fuel cell at a predetermined reference frequency,
measure an impedance value of the fuel cell at a predetermined noise determination frequency, and
set, as the correction value, a value obtained by subtracting the reference impedance value from the impedance value at the noise determination frequency.
   (3)

The fuel cell system according to (2), in which the measuring unit is configured to,
in a state where the load current is pseudo-generated,
perform a predetermined frequency analysis, based on a result of preliminary measurement of the impedance value of the fuel cell at the noise determination frequency, and,
when an amplitude value at the noise determination frequency obtained as a result of the frequency analysis is less than a first threshold,
determine that the noise due to the load current is not generated at the noise determination frequency, return the state to the state where the load current does not flow, and thereafter perform a process of setting the correction value.
   (4)

The fuel cell system according to (3), in which the measuring unit is configured to,
when the amplitude value at the noise determination frequency obtained as the result of the frequency analysis is equal to or greater than the first threshold,
determine that the noise due to the load current is generated at the noise determination frequency, and refrain from performing the process of setting the correction value, and
perform a process of updating the noise determination frequency to a value obtained by subtracting a predetermined frequency from the noise determination frequency at present.
   (5)

The fuel cell system according to any one of (2) to (4), in which the measuring unit is configured to,
when measuring the impedance of the fuel cell based on the correction value,
output a value obtained by subtracting the correction value from the impedance value measured at the noise determination frequency, as a measurement result of the impedance value.
   (6)

The fuel cell system according to (5), in which the measuring unit is configured to,
after measuring the impedance of the fuel cell based on the correction value,
determine whether the noise due to the load current is actually generated at the noise determination frequency, based on a predetermined frequency analysis.
   (7)

The fuel cell system according to any one of (1) to (6), in which the measuring unit is configured to determine the correction value in any of following cases:
at a time of a startup of the fuel cell system;
when an elapsed time from a time of setting the correction value at present is equal to or greater than a second threshold;
when a determination has been made that the noise due to the load current has been actually generated in previous measurement of the impedance of the fuel cell based on the correction value; or
under a light load where the load current is less than a third threshold.
   (8)

A vehicle provided with a fuel cell system,
the fuel cell system including:
a fuel cell;
a power storage configured to store electric power;
an alternating-current load source coupled on a path between the fuel cell and a load; and
a measuring unit configured to measure an impedance of the fuel cell, in which
the measuring unit is configured to
determine a correction value with respect to a reference impedance value in a state where a load current does not flow from the fuel cell to the load, the correction value taking into consideration a generation of a noise due to the load current, and
measure the impedance of the fuel cell, based on the determined correction value.
   (9)

A method of measuring an impedance of a fuel cell of a fuel cell system, the fuel cell system including the fuel cell, a power storage configured to store electric power, and an alternating-current load source coupled on a path between the fuel cell and a load, the method including:
determining a correction value with respect to a reference impedance value in a state where a load current does not flow from the fuel cell to the load, the correction value taking into consideration a generation of a noise due to the load current; and
measuring the impedance of the fuel cell, based on the determined correction value.

Each of the vehicle controller 16 illustrated in FIG. 1 and the impedance measurement device 116 illustrated in FIG. 2 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of each of the vehicle controller 16 illustrated in FIG. 1 and the impedance measurement device 116 illustrated in FIG. 2. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of each of the vehicle controller 16 illustrated in FIG. 1 and the impedance measurement device 116 illustrated in FIG. 2.

1. A fuel cell system comprising:
a fuel cell;
a power storage configured to store electric power,
an alternating-current load source coupled on a path between the fuel cell and a load; and
a measuring unit configured to measure an impedance of the fuel cell, wherein
the measuring unit is configured to
determine a correction value with respect to a reference impedance value in a state where a load current does not flow from the fuel cell to the load, the correction value taking into consideration a generation of a noise due to the load current, and
measure the impedance of the fuel cell, based on the determined correction value.

2. The fuel cell system according to claim 1, wherein the measuring unit is configured to,
in the state where the load current does not flow,
measure the reference impedance value of the fuel cell at a predetermined reference frequency,
measure an impedance value of the fuel cell at a predetermined noise determination frequency, and
set, as the correction value, a value obtained by subtracting the reference impedance value from the impedance value at the noise determination frequency.

3. The fuel cell system according to claim 2, wherein the measuring unit is configured to,
in a state where the load current is pseudo-generated,
perform a predetermined frequency analysis, based on a result of preliminary measurement of the impedance value of the fuel cell at the noise determination frequency, and,
when an amplitude value at the noise determination frequency obtained as a result of the frequency analysis is less than a first threshold,
determine that the noise due to the load current is not generated at the noise determination frequency, return the state to the state where the load current does not flow, and thereafter perform a process of setting the correction value.

4. A vehicle provided with a fuel cell system,
the fuel cell system comprising:
a fuel cell;
a power storage configured to store electric power;
an alternating-current load source coupled on a path between the fuel cell and a load; and
a measuring unit configured to measure an impedance of the fuel cell, wherein
the measuring unit is configured to
determine a correction value with respect to a reference impedance value in a state where a load current does not flow from the fuel cell to the load, the correction value taking into consideration a generation of a noise due to the load current, and
measure the impedance of the fuel cell, based on the determined correction value.

5. A method of measuring an impedance of a fuel cell of a fuel cell system, the fuel cell system including the fuel cell, a power storage configured to store electric power, and an alternating-current load source coupled on a path between the fuel cell and a load, the method comprising:
determining a correction value with respect to a reference impedance value in a state where a load current does not flow from the fuel cell to the load, the correction value taking into consideration a generation of a noise due to the load current; and
measuring the impedance of the fuel cell, based on the determined correction value.
